(19) United States
(12) Patent Application Publication
(10) Pub. No.: US 2019/0208449 A1
(43) Pub. Date: Jul. 4, 2019

(54) MOBILE EDGE PLATFORM SERVERS AND DEVICE AND MESSAGE MANAGEMENT METHODS OF V2X SERVICE THEREOF

(71) Applicant: Industrial Technology Research Institute, Hsinchu (TW)

(72) Inventor: Wei-Cheng WANG, Taichung City (TW)

(21) Appl. No.: 15/858,298

(22) Filed: Dec. 29, 2017

(51) Int. Cl. H04W 36/08; H04W 4/40; H04B 17/318; H04W 64/00

(52) U.S. Cl. CPC H04W 36/08; H04W 64/00; H04B 17/318; H04W 4/40

(57) ABSTRACT

A device and message management method for vehicle-to-everything (V2X) service applied to a mobile edge platform (MEP) for managing a mobile device and V2X messages thereof is provided. The MEP is connected to the mobile device through a first base station. The method includes: obtaining mobile device signal strength information and base station signal strength information from the first base station; determining current location of the mobile device based on the mobile device signal strength information; and generating a mobile device list corresponding to the first base station and a second base station neighboring to the first base station based on the determined current location of the mobile communication device and the base station signal strength information so as to perform a message broadcasting operation on the V2X messages of the mobile device between the first base station and the second base station using the mobile device list.

### TECHNICAL FIELD

The technical field relates to mobile edge platform servers and associated device and message management methods of Vehicle-to-Everything (V2X) service thereof.

### BACKGROUND

With the development of vehicular communication technology, such as vehicle-to-vehicle (V2V), vehicle-to-roadside (V2R), Vehicle-to-Everything (V2X) and other communications technologies for information exchange and sharing, becoming increasingly sophisticated, driving safety systems with vehicular communication technology applications have become more popular. V2X refers to the exchange of information between a vehicle and the outside world, which is a collective term for a series of vehicular communications. V2X communication technology generally consists of six aspects: vehicle-to-vehicle (V2V), vehicle-to-roadside (V2R), vehicle-to-infrastructure (V2I), vehicle-to-pedestrian (V2P), vehicle-to-motorcycle (V2M), vehicle-to-bus (V2T) vehicular communication technology. Among them, V2V technology development has reached maturity. Through the above-mentioned V2X vehicular communication technology, pedestrian, vehicle, road and cloud platforms can be connected, thereby facilitating communication between vehicles and ensuring intelligent cooperation and coordination between vehicles and between vehicle and Road Side Units (RSUs) in order to provide different vehicular application services. In addition, with the front and rear vehicular service system and car network connection, the driver can be provided with the condition of the vehicle, vehicle anomaly warnings, driver behavior analysis, auto pilot, smart traffic, and so on, which can reduce accidents and the impact of traffic on the environment, enhance transportation safety and reduce traffic accidents.

V2X in recent years has the low latency requirement of 100 ms or even 10 ms, and thus a new network framework known as Mobile Edge Computing (MEC) has come to be. MEC generally involves placing a server at the proximal end of the backhaul network of the base station and constructing a lightweight cloud that accommodates cloud computing and storage capabilities in order to intercept data sent back to the backend core network to the server for computing processing, thereby moving application services traditionally setup in the data center to the Mobile Edge Platform (MEP), allowing users to use application services deployed on the MEP and featuring the following advantages: (1) Nearby users can effectively decrease the service latency time; (2) Data on MEC can effectively reduce the load of data transmitted through the core network; (3) Provide service quality parameters at the wireless network end in order to ensure service quality, thereby enhancing user experience.

The existing V2R communication-based driving safety systems mostly collect vehicle or road information within range through the RSU, thus monitoring the driving environment of vehicles within the region, sending sorted information to all the vehicles within the signal range and sending warning messages to vehicles within the region whenever necessary, so as to warn the vehicles needing to be warned, such as warnings for road ahead, traffic accident warnings, cooperative collision warnings, etc. However, the warning messages of existing V2R or V2X communication-based driving safety systems are usually sent to all of vehicles within a region through broadcasting, and most V2X service systems set up the RSU at road intersection. If the future use of Long Term Evolution (LTE) technology, Long Term Evolution Advanced (LTE-A) technology and so on can cover all areas of the roads, the signal service range among different RSUs will overlap and the overlap range will produce signal blind spots as the signal strength changes. As a result, when vehicles move to the RSU signal edge, information of vehicles and road conditions outside the edge will not be received. For example, when a car moves to the RSU signal edge, it may not be able to receive vehicle and road condition information collected at another RSU signal edge. In other words, vehicles in another region may be right ahead, or there is traffic congestion ahead, but the information cannot be accessed through the original RSU and will only be known after actually entering the region. This is likely to lead to traffic safety concerns and can't effectively reduce accidents from taking place.

### SUMMARY

Mobile edge platform servers applied to a mobile edge computing network and device and message management methods for vehicle-to-everything (V2X) service applied to a mobile edge platform (MEP) are provided.

In an exemplary embodiment, a device and message management method for vehicle-to-everything (V2X) service applied to a mobile edge platform (MEP) for managing a mobile device and V2X messages thereof is provided, wherein the mobile edge platform is connected to the mobile device through a first base station and the first base station is neighboring to a second base station. The method comprises the steps of: obtaining mobile device signal strength information and base station signal strength information from the first base station; determining current location of the mobile device based on the mobile device signal strength information; and generating a mobile device list corresponding to the first base station and the second base station based on the determined current location of the mobile device and the base station signal strength information, wherein the mobile device is added to the mobile device list when determining that the current location of the mobile device is located at a signal edge between the first base station and the second base station.

In another exemplary embodiment, a device and message management method for vehicle-to-everything (V2X) service applied to a mobile edge platform (MEP) for managing a mobile device and V2X messages thereof is provided, wherein the mobile edge platform is connected to the mobile device through a first base station and the first base station is neighboring to a second base station. The method comprises the steps of: receiving a report message regarding whether the mobile device has triggered a predetermined handover event and base station signal strength information provided by the mobile device from the first base station; determining current location of the mobile device based on the report message; and generating a mobile device list corresponding to the first base station and the second base station based on the determined current location of the mobile device and the base station signal strength information, wherein the mobile device is added to the mobile device list when determining that the current location of the mobile device is located at a signal edge between the first base station and the second base station.

Another exemplary embodiment of a mobile edge platform server applied to a mobile edge computing network for managing a mobile device includes a mobile edge platform. The mobile edge platform comprises a communication device and a controller. The communication device is configured to perform signal transmission and reception with at least one first base station and wireless transmission and reception with a mobile device. The controller is configured to obtain mobile device signal strength information and base station signal strength information from the first base station via the communication device, determine current location of the mobile device based on the mobile device signal strength information, and generate a mobile device list corresponding to the first base station and the second base station based on the determined current location of the mobile device and the base station signal strength information, wherein the controller adds the mobile device to the mobile device list when determining that the current location of the mobile device is located at a signal edge between the first base station and the second base station.

Another exemplary embodiment of a mobile edge platform server applied to a mobile edge computing network for managing a mobile device includes a mobile edge platform. The mobile edge platform comprises a communication device and a controller. The communication device is configured to perform signal transmission and reception with at least one first base station and wireless transmission and reception with the mobile device. The controller is configured to receive a report message regarding whether the mobile device has triggered a predetermined handover event and base station signal strength information provided by the mobile device from the first base station via the communication device, determine current location of the mobile device based on the report message, and generate a mobile device list corresponding to the first base station and the second base station based on the determined current location of the mobile device and the base station signal strength information, wherein the controller adds the mobile device to the mobile device list when determining that the current location of the mobile device is located at a signal edge between the first base station and the second base station.

Methods disclosed above may be practiced by the devices or systems disclosed above which are hardware or firmware capable of performing particular functions and may take the form of program code embodied in a memory and/or embodied in a computer-readable storage medium/computer program product, combined with specific hardware. When the program code is loaded into and executed by an electronic device, a controller, a computer processor or a machine, the electronic device, the processor, the computer or the machine becomes an apparatus or system for practicing the disclosed method.

### BRIEF DESCRIPTION OF THE DRAWINGS

The application will become more fully understood by referring to the following detailed description with reference to the accompanying drawings, wherein:

FIG. 1 is a block diagram illustrating a mobile communication environment according to an embodiment of the application;

FIG. 2 is a schematic diagram of a hardware structure of a mobile edge platform according to an embodiment of the application;

FIG. 3 is a schematic diagram of a functional module architecture of the mobile edge platform according to an embodiment of the application;

FIG. 4 is a flowchart of a device and message management method for vehicle-to-everything (V2X) service applied to a mobile edge platform according to an embodiment of the application;

FIG. 5 is a flowchart of a device and message management method for vehicle-to-everything (V2X) service applied to a mobile edge platform according to another embodiment of the application;

FIGS. 6A-6B show a schematic diagram illustrating an exemplary embodiment of mobile device list and vehicle-to-everything (V2X) message management between the mobile edge platforms;

FIGS. 7A-7B show a message sequence chart illustrating the device and message method of V2X service when the mobile device is located at a signal boundary according to an embodiment of the application; and

FIGS. 8A-8B show a message sequence chart illustrating the device and message method of V2X service when the mobile device is located at a signal boundary according to another embodiment of the application.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that the embodiments may be realized in software, hardware, firmware, or any combination thereof.

Embodiments of the application provide device and message management system and methods for vehicle-to-everything (V2X) service assisted by mobile edge platforms (MEPs) based on a mobile edge computing (MEC) environment, which can obtain neighboring relationships between base stations and information of the signal strength collected from mobile devices by collecting base station signals through the MEPs and based on which the neighboring relationship with each of neighboring base stations can be established, while the signals of vehicles in respective mobile device can be monitored, such that the current locations can be determined and the mobile devices at the signal edges of each neighboring base station can be detected. When the mobile device at the edge enters a neighboring MEP, the MEP can notify the neighboring MEP to acquire related mobile device information required and transmit a corresponding safety message to the respective neighboring MEP, thus effectively resolving mobile device's inability to timely obtain necessary information available in neighboring MEP, such as vehicular safety messages and regional road condition and other information, to result in safety concerns when the mobile device reaches the service edges of respective MEPs.

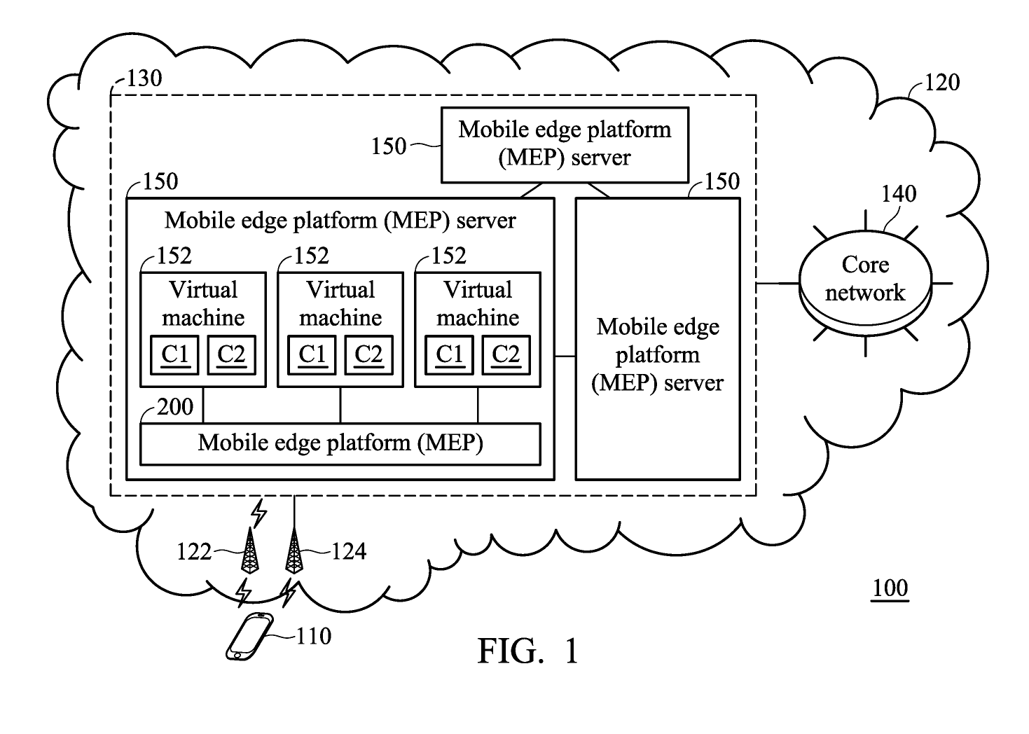

FIG. 1 is a block diagram illustrating a mobile communication environment according to an embodiment of the application. In the mobile communication environment 100, a mobile device 110 is wirelessly connected to a base station 122 or a base station 124 of a service network 120 through the space interface to obtain the wireless access service. Generally speaking, the base stations 122 and 124 may be base stations or access stations or may be home base stations of a wideband CDMA system or evolved-Node-Bs (eNBs) of a long term evolution system and the base stations 122 and 124 may be handled by a control node to provide the necessary wired/wireless transmission of the service network 120. The mobile device 110 is also referred to as a user equipment (referred to as UE) or a mobile station, and may support various radio access technologies. The mobile device 110 may be a device such as a mobile phone, a computer system, a vehicle or the like. The mobile device 110 may at least include a communication device and a controller for performing wireless transmission with the base station 122 and the base station 124. The mobile device 110 may perform wired communication and/or wireless communication of voice and/or data services with the service network 120 through the base stations 122 and 124. The wireless communications between the mobile device 110 and the service networks 120 may be in compliance with various wireless technologies, such as the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA 2000) technology, Time Division-Synchronous Code Division Multiple Access (TD-SCDMA) technology, Worldwide Interoperability for Microwave Access (WiMAX) technology, Long Term Evolution (LTE) technology, Long Term Evolution Advanced (LTE-A) technology, and others. The service network 120 includes a mobility edge computing network 130 and a core network 140. A plurality of mobile edge platform servers 150 (also referred to as mobile edge hosts) are connected to each other by a wireless or wired connection to form a mobile edge computing network 130, but the application is not limited thereto. The core network 140 is responsible for performing mobility management, network-side authentication, and interfaces with public/external networks (e.g., the Internet). For example, the core network 140 may be an Evolved Packet Core (EPC) which includes a Home Subscriber Server (HSS), Mobility Management Entity (MME), Serving Gateway (S-GW), and Packet Data Network Gateway (PDN-GW or P-GW), but the application is not limited thereto.

The mobile edge computing (MEC) network 130 is connected between the core network 140 and the mobile communications device 110 to provide a mobile edge computing environment for providing lightweight clouds at near side of the backhaul network of the base stations 122, 124 to provide cloud computing and storage capabilities for intercepting data back to the back-end core network 140 to the mobile edge platform server 150 for processing. Each mobile edge platform server 150 further includes a mobile edge platform (MEP) 200 and a plurality of virtual machines and/or containers 152. The mobile device 110 may be wired/wirelessly connected to the different MEPs 200 of the MEC network 130 through the base stations 122 and 124, respectively. The base stations 122 and 124 may communicate with each other via a wired connection such as the Internet, a wired LAN, etc., and/or a wireless connection such as a wireless network, a WCDMA network, a 3G network, a wireless local area network (WLAN), a Bluetooth network and the like to connect to the MEC network 130 to access each of the MEPs 200 in the MEC network 130 and perform communication and data transmission with each other. For example, the base station 122 may be connected to the MEC network 130 through a wireless connection, while the base station 124 may be connected to the MEC network 130 by an Ethernet cable and may further be connected to the Internet and then connected to the core network 140 via the Internet, but the application is not limited thereto. In one embodiment, the mobile device 110 may separately access one of the MEPs 200 in the MEC network 130 through the base station 122 and the base station 124. In another embodiment, the mobile device 110 may access one of the MEPs 200 in the MEC network 130 through the base station 122, and access another MEP 200 in the MEC network 130 through the base station 124. The MEP 200 runs a variety of services with low latency requirements, data analytics assistance and regional connectivity, including V2X, Virtual Reality, Augmented Reality, Instant Online games, eHealth and video analytics and so on, but the application is not limited thereto. These services running on the MEP 200 all operate in the corresponding virtual machines or containers 152 of the MEP server 150. To simplify the description, in the following embodiments, the virtual machines and/or containers 152 are collectively referred to as a virtual machine 152. Each virtual machine 152 includes at least one UE context corresponding to one or more specific services of users of one or more mobile devices 110. For example, the first UE context C1 and the second UE context C2 may be included in the virtual machine 152, and the first UE context C1 and the second UE context C2 may correspond to different uses of the same service, the same user corresponding to different services, or different users corresponding to different services. The UE context is contextual data for each user using the service. For example, in one embodiment, when the service is a V2X service, the UE context may be necessary V2X information such as various driving dynamics such as velocity (vel), type (type), heading direction (heading) and other information for the UE itself, and the UE context may be a file in a format such as JSON, XML or YAML, but the application is not limited thereto.

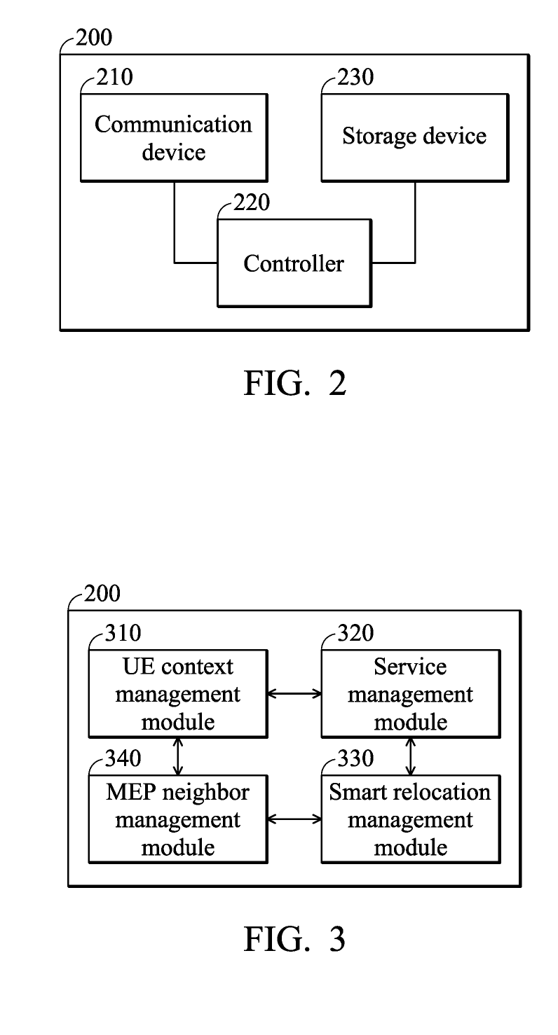

FIG. 2 is a schematic diagram of a hardware structure of a mobile edge platform according to an embodiment of the application. As shown in FIG. 2, the mobile edge platform 200 includes at least a communication device 210, a controller 220, and a storage device 230.

The communication device 210 is configured to receive information about the mobile device 110, the base stations 122 and 124, and other MEPs 200. To be more specific, the communication device 210 may receive a signal from the current connected network and transmit the signal to the current connected network. The communication device 210 may include a wired communication module that may be coupled/electrically connected to one or more wired networks and may allow utilization of a wired network to communicate with one or more additional devices, computer servers, and/or network nodes. The communication device 210 may further include a wireless module, may be coupled/electrically connected to one or more antennas (not shown), and may allow a wireless network to communicate with one or more additional devices, a computer server and/or network nodes (such as base stations, etc.). The mobile edge platform 200 may support various communication protocols such as CDMA, GSM, EDGE, HSDPA, Wi-Fi (e.g., IEEE 802.11a/b/g/n), Bluetooth and Wi-MAX, and protocols such as email, instant messaging (IM), and smart messaging services and other RATs standards, but the application is not limited thereto. Specifically, the communication device 210 is coupled/electrically connected to the controller 220 and bidirectionally links with communication devices having the same communication channel and protocol so as to receive external messages such as messages sent by each mobile device 110 and the MEP 200 and then output received messages to the controller 220, and broadcasts the message output by the controller 220 to the outside through the communication device 210.

The controller 220 may be a general-purpose processor, a Micro Control Unit (MCU), a Digital Signal Processor (DSP), or the like, which includes various circuits for providing the functions of data processing and computing, but the application is not limited thereto. The controller 220 which is coupled/electrically connected to the communication device 210 and the storage device 230, may be used to load and execute a series of instructions and/or program codes from the storage device 230 to control the operations of the communication device 210 and the storage device 230 to perform the UE context migration management methods of the application, the details of which will be described more in the following paragraphs.

The storage device 230 may be a non-volatile storage medium (e.g., Read-Only Memory (ROM), Flash memory, magnetic tape, hard disk, or optical disc), or a volatile storage medium (e.g., Random Access Memory (RAM)), or any combination thereof for storing data, such as intermediate data generated during the calculation process and the execution result information and so on. The storage device 230 may also store instruction sets and/or program code modules that can be executed by the controller 220, but the application is not limited thereto. Generally speaking, program code modules contain routines, programs, objects, components, and so on. The storage device 230 may further store various items of data required for the operation, such as UE contexts, difference data, and so on, but the application is not limited thereto.

As will be comprehended by persons skilled in the art, the circuits in the controller 220 will typically comprise transistors that are configured in such a way as to control the operation of the circuitry in accordance with the functions and operations described herein. As will be further comprehended, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems and those skilled in the art will understand that the present application is not limited thereto.

Although they are not shown, the mobile device 110 may also comprise a communication device and a controller. The communication device is configured to provide wireless transmission and reception functions to communication between each of the base stations 122 and 124 and each of the MEPs 200 in the mobile communication environment 100, and the controller is used to control the operation of the communication devices. The operations of the communication device and the controller of the mobile device 110 are similar to that of the embodiment shown in FIG. 2, and thus details are omitted here for brevity. Similarly, although they are not shown, each of the base stations 122 and 124 may also comprise a communication device and a controller. The communication device is configured to provide wireless transmission and reception functions to communication between each of the mobile devices 110 and each of the MEPs 200 in the mobile communication environment 100, and the controller is used to control the operation of the communication devices. The operations of the communication device and the controller of which are similar to that of the embodiment shown in FIG. 2, and thus details are omitted here for brevity.

FIG. 3 is a schematic diagram of functional module architecture of the MEP 200 according to an embodiment of the application. The functional module architecture of the MEP 200 includes a UE context management module 310, a service management module 320, a smart relocation management module 330, and an MEP neighbor management module 340. The UE context management module 310, the service management module 320, the smart relocation management module 330, and the MEP neighbor management module 340 can be stored in the storage device 230 (e.g., memory) of the MEP 200, and can be loaded and executed at an appropriate timing by the controller 220 of the MEP 200 to perform the signal-edge UE list generation and UE context migration management method applied to a MEP of the present application. To be more specific, the controller 220 may perform the device and message management method for V2X service applied to the MEP 200 of the present application by controlling the operations of the UE context management module 310, the service management module 320, the smart relocation management module 330 and the MEP neighbor management module 340.

The UE context management module 310 mainly carries out the importation, retrieval, deletion and termination of the UE contexts of one or more users on the virtual machine 152 through exclusive application programing interface (API). The UE context management module 310 can obtain a storage location where a specific UE context is located through dedicated API, and retrieve the specific UE context from this storage location. The UE context management module 310 may also send messages to other neighboring MEPs 200 to deliver the extracted specific UE context to the designated MEP 200. The service management module 320 carries out status inquiry and activation operations on various services on the virtual machine 152 through the dedicated API. The smart relocation management module 330 is responsible for communicating with other MEP 200 related to UE context migration and receiving migration events triggered at the mobile device 110. For example, the above migration events may include time indicators for the mobile device 110 at which a migration starts and at which the migration has completed. The MEP neighbor management module 340 can communicate with neighboring MEP 200 (periodically communication within a predetermined time period or communication at the time of a specific event triggered) to exchange each other's base station information, collect information of the neighboring MEP 200 and manage and record information of the neighboring MEP 200, to establish a neighbor relationship based on the obtained base station information so as to know which base stations are nearby and which MEP these base stations belong to. For example, when the base station information of the mobile edge platform MEP_A includes the signal information of the base station 1 and the base station information of the mobile edge platform MEP_B includes the signal information of the base station 1 and the base station 2, the mobile edge platform MEP_A and the mobile edge platform MEP_B can be considered as having a neighbor relationship. More particularly, when two different MEPs can detect a signal strength of the same base station, it means that the signal service ranges of these two MEPs will overlap. Therefore, it may happen that when the mobile device moves to the base station's signal edge, some situations taking place may not be prevented in advance because of the inability to obtain relevant information about the neighboring base stations, thus needing special handling by performing the device and message management methods for V2X service of the application.

The MEP 200 may have multiple respective virtual machines 152, while the various services running on the MEP 200 are operated on the corresponding virtual machines 152 of the MEP 200. The respective virtual machine 152 frameworks should at least contain multiple UE contexts. The above-mentioned UE context not only accommodates the access of corresponding services in the virtual machine 152, but also accommodates direct UE context access by the MEP 200 through the API, thereby responding to the user's demand for the MEP switching and service migration when the user is moving.

More particularly, the controller 220 may access the corresponding UE contexts of the service that needs to be migrated through the UE context management module 310, perform a status inquiry and activation on a designated service within the virtual machine 152 through the service management module 320, carry out relevant base station information and UE context migration communication with other MEP 200 and receive the moving events triggered by the mobile devices 110 through the smart relocation management module 330, and obtain base station information of neighbor MEPs through the MEP neighbor management module 340, so as to perform a message management operation corresponding to the V2X service in response to the MEP switching and the service migration requirement caused by the user movement to broadcast the V2X messages with migration needs to corresponding MEP. The details of which will be described later.

Although they are not shown, the MEP 200 may further comprise other functional units, such as an Input/Output (I/O) device (e.g., physical button, keyboard, etc.), a display device, an audio device or the like, and the application is not limited thereto.

It should be understood that each of the elements or modules in the present embodiments may be a device having a corresponding function, which can have the appropriate hardware circuits or elements to perform the corresponding function, however, the device is not limited to be entity device, which can also be a virtual device having program and software with respective functions or a device having capabilities for processing and running the program and software. The manner of operations of the respective elements can further refer to the following description of the methods. In one embodiment, the UE context management module 310, the service management module 320, the smart relocation management module 330, and the MEP neighbor management module 340 may be implemented as a chip, a circuit board, or a circuit, and the controller 120 may control the operations of the UE context management module 310, the service management module 320, the smart relocation management module 330 and the MEP neighbor management module 340 to perform the device and message management method of V2X service applied to the MEP of the present application, which will be discussed further in the following paragraphs.

Specifically, the device and message management methods for V2X service of the application can first establish the neighboring relationship between the MEPs to understand potential MEPs that may need vehicle safety information, analyze and establish a mobile device list of mobile devices reaching the neighboring base station's signal edge, and determine V2X message (e.g., vehicle safety information) of which mobile device needs to be sent to the neighboring MEP. Thereafter, the MEP may obtain the V2X service messages of each mobile device in the mobile device list from the V2X application service and sent them to the corresponding MEP.

In one embodiment, any MEP in the mobile edge computing network may generate a mobile device list of signal edge of neighboring base stations according to the signal strength of each base station measured by the mobile device, and then perform a message broadcasting operation of the mobile device at the signal edge with and a MEP corresponding to the neighboring base station according to the mobile device list.

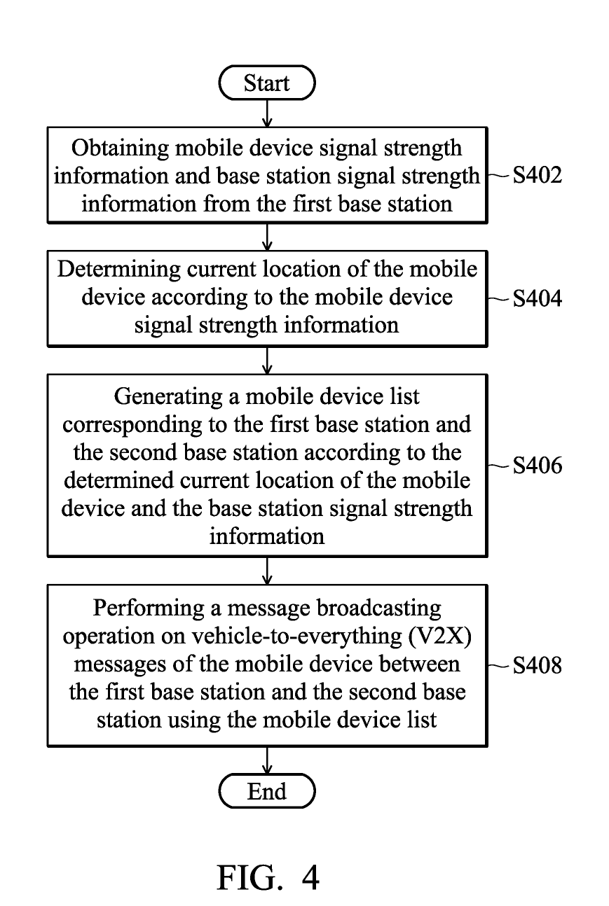

FIG. 4 is a flowchart of a device and message management method for V2X service applied to a MEP according to an embodiment of the application. Please refer together with FIG. 1, FIG. 2, FIG. 3 and FIG. 4. The device and message management method for V2X service applied to the MEP of the application may be applied to any MEP in a mobile edge computing network, such as the MEP 200 as shown in FIG. 2 and performed by the controller 220 of the MEP 200 for managing a mobile device and its V2X messages. The V2X messages can be various types of message applied to a vehicle networking (V2X) service, such as vehicle-related safety messages or other V2X messages. In this embodiment, it is assumed that the mobile communication device 110 can be connected to the MEP 200 through the base station 122 (first base station), wherein the MEP 200 is connected to the mobile device 110 through the base station 122 and the base station 122 is neighboring to a base station 124 (second base station). The MEP 200 provides a V2X service to the mobile device 110 and stores the V2X messages corresponding to the V2X service for the user of the mobile device 110. It should be understood that, in this embodiment, the base station 124 can be any neighboring base station of the base station 122, and therefore, when there are multiple base stations 124, the method described in this embodiment may be applied to each neighboring base station. Similarly, the mobile device 110 can be any mobile device within the service coverage of the base station 122.

First, in step S402, the MEP 200 obtains mobile device signal strength information from the base station 122 and base station signal strength information from the base station 122. To be more specific, the mobile device 110 may periodically measure the signals of the currently connected base station 122 and the neighboring base station 124, record the measured signal strength information of each base station, and periodically report to the base station 122 about the measured mobile device signal strength information and the base station signal strength information. The signal strength information of the mobile device may be used to indicate the signal strength of the currently connected base station 122 received/measured by the mobile device 110, and the base station signal strength information may at least include signal strength information of all neighboring base stations 124 that can be received/measured by the mobile device 110. In one embodiment, the base station signal strength information may include at least a measured Reference Signal Receiving Power (RSRP) and a Reference Signal Received Quality (RSRQ) of the neighboring base station 124. The RSRP is the average signal strength of the downlink reference signals measured by the mobile device 110, which is used to indicate the signal quality of neighboring base station. The RSRQ represents the signal strength of neighboring BS measured. The mobile device 110 can collect RSRP and RSRQ and related information sent by neighboring base station, which are compiled into a measurement report and sent back to the base station 122 for handover decision-making use. The controller 220 of the MEP 200 may obtain the base station signal strength information collected by all the mobile devices 110 on the base station 122 from the base station 122 through the communication device 210.

In one embodiment, the mobile device signal strength information and the base station signal strength information may be periodically sent by the base station 122 to the MEP 200. In another embodiment, the controller 220 of the MEP 200 may transmit a signal strength measurement request to the base station 122 via the communication device 210 to request the base station 122 to provide the mobile device signal strength information and the base station signal strength information. In this embodiment, the controller 220 of the MEP 200 transmits the signal strength measurement request including a measurement configuration data to the base station 122 via the communication device 210 to transmit the above measurement request to the mobile device 110 through the base station 122. The measurement configuration information may at least include details about what information the mobile device is expected to report, for example, reporting the base station signal strength information including the RSRP data and RSRQ data.

After receiving the measurement request, the mobile device 110 performs a corresponding signal strength measurement according to the measurement configuration data in the measurement request message to obtain the mobile device signal strength information and the base station signal strength information. Specifically, the mobile device 110 may know that the signal strengths of the current base station 122 and the neighboring base station 124 are to be measured based on the measurement request message to generate a measurement report at least including measured reference signal receiving power (RSRP) data and reference signal received quality (RSRQ) data of the neighboring base stations, and then transmits the measurement report to the MEP 200 through the base station 122. The base station signal strength information includes signal strengths of all base stations in a signal range detectable by the mobile device 110.

After receiving the measurement report that includes the mobile device signal strength information and the base station signal strength information measured by the mobile device 110 through the communication device 210, in step S404, the controller 220 of the MEP 200 determines current location of the mobile device 110 according to the mobile device signal strength information. Specifically, since the mobile device signal strength information indicates the signal strength of the currently connected base station 122 received by the mobile device 110, the controller 220 can determine the signal strength received by mobile device 110 based on the mobile device signal strength information, thereby determining the location of the mobile device 110, whether the current location of the mobile device 110 is at the signal edge of the base station 122 so as to determine whether the current location of the mobile device 110 is in the signal edge of the base station 122 and the base station 124.

After the controller 220 determines the current location of the mobile device 110, in step S406, the controller 220 then generates a mobile device list corresponding to the base station 122 and the neighboring base station 124 according to the determined current location of the mobile device 110 and the base station signal strength information collected in step S402. In particular, when the current location of the mobile device 110 is the signal edge of the base station 122 and base station 124, the controller 220 adds the mobile device 110 to the mobile device list corresponding to the base station 122 and the base station 124. Specifically, the mobile device list corresponding to the base station 122 and the base station 124 includes all the mobile devices 110 located at the signal edges of the base station 122 and the neighboring base station 124, which is also referred to as an edge mobile device list. The MEP 200 can obtain the base station signal strength information collected by all the mobile devices 110 on the base station 122 through the base station 122 to determine which mobile device 110 is possibly be the edge mobile device located at the signal edge and inquire signal information recorded by the edge mobile devices. If one edge mobile device can receive signals from the neighboring base station 124, this edge mobile device will be added to the corresponding mobile device list of neighboring base station requiring to be sent. In particular, edge mobile device is used to represent any mobile device whose location is located at the signal edge within signal coverage ranges of the respective base station.

In one embodiment, the controller 220 may determine whether the reference signal receiving power (RSRP) corresponding to the neighboring base station 124 is greater than a first threshold value and whether the reference signal received quality (RSRQ) data corresponding thereto is greater than a second threshold value after determining that the current location of the mobile device 110 is at the signal edge of the base station 122 according to the mobile device signal strength information, and it is determined that it is neighboring to/near the neighboring base station 124 when determining that the reference signal receiving power data is greater than the first threshold value and the reference signal received quality data is greater than the second threshold value. To be more specific, the MEP 200 may determine whether it is neighboring to a certain MEP according to the RSRP data and the RSRQ data of the neighboring base stations measured in the measurement report. For example, when the collected RSRP data of a neighboring eNB2 is greater than a preset reference signal receiving power threshold and its RSRQ data is greater than a preset reference signal received quality threshold (i.e., eNB2 RSRP>RSRP_Threshold && eNB2 RSRQ>RSRQ_Threshold), it indicates that the mobile device 110 is adjacent to the base station eNB2 and thus needs to transmit relevant data of the mobile device 110 to the base station eNB2. Therefore, the mobile device 110 can be added to the corresponding mobile device list of the base station eNB2. In other words, the corresponding mobile device list of the base station eNB2 represents all of the mobile devices located at the signal edge of the base station eNB2 that may need to transmit data to the base station eNB2 in advance.

After generating the mobile device list corresponding to the neighboring base stations 124, in step S408, the controller 220 of the MEP 200 performs a message broadcasting operation on V2X messages of the mobile device between the base station 122 and the neighboring base station 124 using the mobile device list corresponding to the base station 122 and the neighboring base stations 124 through the communication device 210.

In some embodiments, the controller 220 of the MEP 200 may obtain neighboring MEP information about the neighboring base station 124 to perform the message broadcasting operation on V2X messages of the mobile device 110 between the base station 122 and the neighboring base station 124 through its corresponding neighboring MEP. To be more specific, the MEP neighbor management module 340 of the MEP 200 may communicate with the MEP neighbor management modules of other MEPs in advance to obtain information about those neighboring MEPs 124 and exchange each other's base station information, and the controller 220 may perform the base station information acquisition processing on each neighboring MEP 124 through the MEP neighbor management module 340 and establish the neighboring relationships with the neighboring MEPs according to the base station information and record the corresponding relationships between the base stations and the respective MEPs.

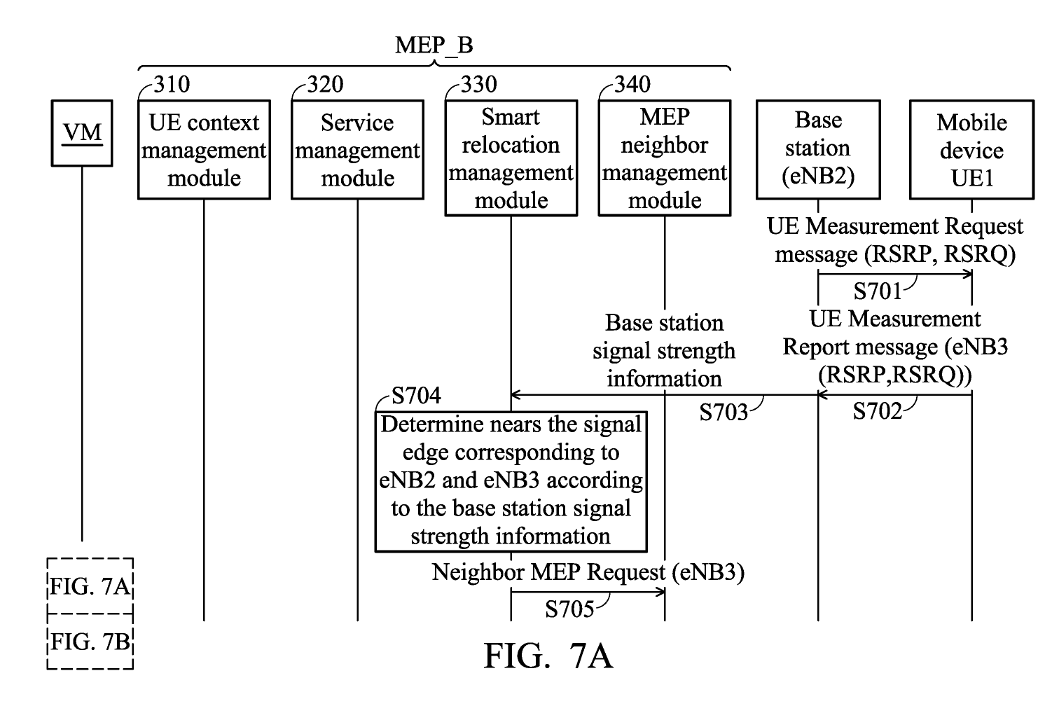

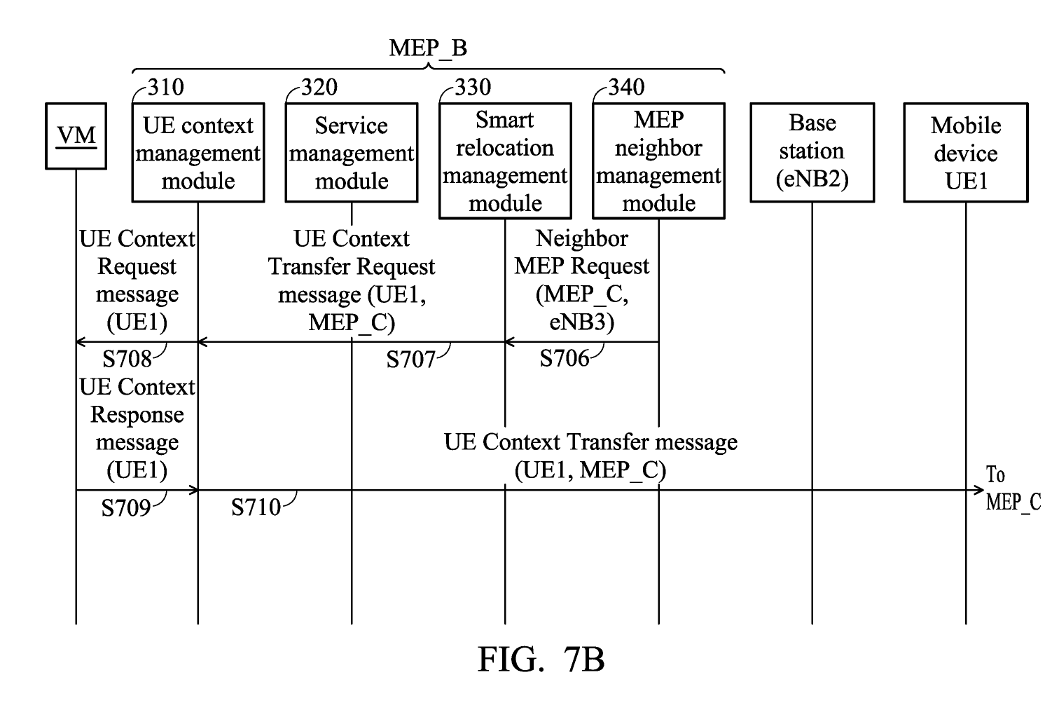

For example, in this embodiment, the mobile device list for the neighboring base station 124 includes at least the mobile device 110, so the V2X messages corresponding to the mobile device 110 such as the vehicle speed, volume, model, and heading direction information and other vehicle safety information of the mobile device 110 are obtained and then the vehicle safety information of the mobile device 110 and/or road traffic information are transmitted to the neighboring MEP via the communication device 210. The neighboring MEP may further broadcast the V2X message received, through the neighboring base station 124, to all the mobile devices under it, and complete the message broadcasting operation on the V2X messages. In this way, the mobile devices at the signal overlapping areas between the base stations can still receive the mobile device and traffic information collected at the signal edges of the neighboring base stations, and thus when there is an accident in front or blocked in the front of the road, the blocked area can be avoided or other route planning that avoids the blocked area can be determined in time so as to effectively reduce the occurrence of the accident. The related device and message management of the V2X messages will be described in more detail with referring to subsequent FIGS. 7A-7B.

In other embodiments, the MEP 200 may generate a mobile device list by determining whether the mobile device 110 can measure a designated handover event specified by the 3rd Generation Partnership Project (3GPP) organization, and then performs the message broadcasting operation of the mobile devices at the signal edges according to the mobile device list and the MEP corresponding to the neighboring base station. In this embodiment, the MEP 200 predicts which MEP is adjacent to the mobile device 110 through determining whether the mobile device 110 triggers a specific handover event. The specific handover event is a 3GPP A1˜A5 event. Specifically, the 3GPP defined A1˜A5 events represent the comparison of signal strengths for the serving cell and the neighboring cell measured by the mobile device. Among them, the service cell represents the base station at which the mobile device is currently camped on, and the neighboring cell represents the base station near the base station at which the mobile device is currently camped on.

The mobile device 110 may determine whether the A1˜A5 events have been triggered through the measurement value of the reference signal received power (RSRP). The A1 to A5 events respectively have different trigger conditions. The trigger condition for the A1 event is that the signal quality of the serving cell is higher than a preset threshold, and the trigger condition of the A2 event is that the signal quality of the serving cell is lower than the preset threshold. The trigger condition of A3 event is that the signal quality of neighboring cells is better than the signal quality of the serving cell, the trigger condition of A4 event is that the signal quality of neighboring cell is better than the preset threshold, and the trigger condition of A5 event is the signal quality of the serving cell is lower than the preset threshold and the signal quality of the neighboring cell is better than the preset threshold. For example, the A2 event will be triggered when the signal quality of the serving cell is lower than the preset threshold, and the A1 event will be triggered when the signal quality of the serving cell is higher than the preset threshold. In one embodiment, the controller 220 of the MEP 200 may transmit, via the communication device 210, a measurement request including a measurement configuration data indicating whether the mobile device measures about whether the A2 event has been triggered to the base station 122 to be further transmitted to the mobile device 110 via the base station 122, and then determine whether the mobile device 110 is located at the signal edge of the base station 122 according to whether the mobile device 110 generates a trigger report about the above A2 event. The A2 event can be triggered when the signal quality of the serving cell is below a preset threshold, and the controller 220 of the MEP 200 determines that the mobile device is located at the signal edge of the serving cell. The A2 event will not be triggered when the signal quality of the serving cell is greater than or equal to the preset threshold, and the MEP determines that the mobile device is not located at the signal edge of the serving cell.

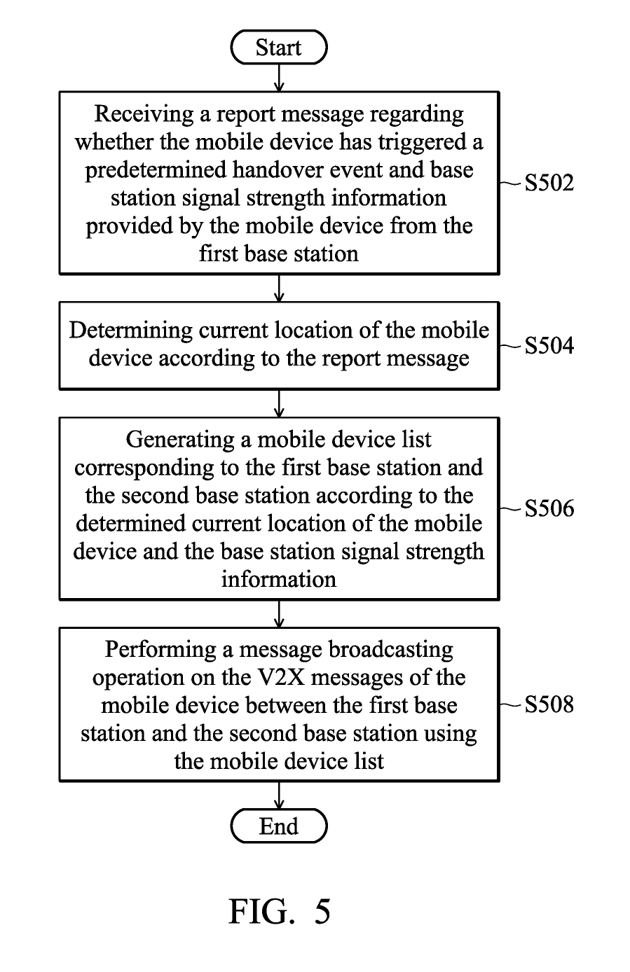

FIG. 5 is a flowchart of a device and message management method for V2X service applied to a MEP according to another embodiment of the application. Please refer together with FIG. 1, FIG. 2, FIG. 3 and FIG. 5. The device and message management method for V2X service applied to the MEP of the application may be applied to any MEP in a mobile edge computing network, such as the MEP 200 as shown in FIG. 2 and performed by the controller 220 of the MEP 200 for managing a mobile device and its V2X messages. The V2X messages can be various types of message applied to a vehicle networking (V2X) service, such as vehicle-related safety messages or other V2X messages. In this embodiment, it is assumed that the mobile communication device 110 can be connected to the MEP 200 through the base station 122 (first base station) to manage V2X messages of each mobile device 110, wherein the MEP 200 is connected to the mobile device 110 through the base station 122 and the base station 122 is neighboring to a base station 124 (second base station). The MEP 200 provides a V2X service to the mobile devices 110 and stores the V2X messages corresponding to the V2X service for the users of the mobile devices 110.

First, in step S502, the controller 220 of the MEP 200 receives, through the communication device 210, a report message regarding whether the mobile device 110 has triggered a predetermined handover event and base station signal strength information provided by the mobile device 110 from the base station 122. In this embodiment, the predetermined handover event is set as the foregoing LTE A2 handover event indicating that the signal quality of the base station 122 is lower than a preset threshold, and the report message can be used to indicate whether the mobile unit 110 has triggered the LTE A2 handover event. For example, assuming that the mobile device 110 is located within the service range of the base station 122 and the base station 122 is neighboring to the base station 2 and the base station 3, the serving cells are the base station 122 while the neighboring cells are the base station 2 and the base station 3. Therefore, the mobile device periodically measures the signal strength of the base station 122, the signal strengths of the base station 2 and the base station 3, and determines whether a predetermined A2 handover event has been triggered. When the mobile device 110 determines that the signal quality of the base station 122 is lower than a preset threshold TH1 according to the measured signal strength data, it indicates that the A2 handover event is triggered, and thus it transmits a measurement report message indicating that the A2 event has been triggered and the detected signal strength information of the neighboring base station to the MEP 200 through the base station 122. In one embodiment, the base station signal strength information includes at least RSRP information of the base station 124.

After receiving the report message and the base station signal strength information provided by the mobile device 110 from the base station 122, in step S504, the controller 220 of the MEP 200 determines a current position of the mobile device 110 according to the report message. In one embodiment, the controller 220 may determine the current position of the mobile device 110 according to the report message by the following steps: determining that the current location of the mobile device 110 is the signal edge of the base station 122 when the report message indicates that the mobile device 110 has triggered the predetermined handover event. When the signal quality of the base station 122 is lower than the preset threshold, the A2 event is triggered, and thus the controller 220 of the MEP 200 determines that the mobile device 110 is located at the signal edge of the base station 122. When the signal quality of the base station 122 is greater than or equal to the preset threshold, the A2 event will not be triggered, and thus the MEP determines that the mobile device 110 is not located at the signal edge of the base station 122.

After determining the current location of the mobile device 110, in step S506, the controller 220 of the MEP 200 generates a mobile device list corresponding to the base station 122 and the base station 124 according to the determined current location of the mobile device 110 and the base station signal strength information. In some embodiments, the base station signal strength information includes at least the RSRP data of the base station 124, and the controller 220 generates the mobile device list corresponding to the base station 122 and the base station 124 according to the determined current location of the mobile device 110 and the base station signal strength information may include the following steps: determining whether the RSRP data of the base station 124 is greater than a first threshold after determining that the current position of the mobile device 110 is the signal edge; and determining that the current position of the mobile device 110 is the signal edge of the base station 122 and the base station 124 when the RSRP is greater than the first threshold; adding the mobile device 110 to the mobile device list corresponding to the base station 122 and the base station 124. Specifically, the MEP 200 may consider the mobile device that receives the above measurement report message indicating that the A2 event has triggered as the edge mobile device. Thereafter, the MEP 200 may further determine, according to the signal strength of the neighboring base stations, which mobile device is to be classified in the corresponding mobile device list of that neighboring base station. For example, when the signal strength of the neighboring base station includes the signal strength of the base station 2, it indicates that the mobile device is closer to the base station 2, that is, the mobile device is located at the signal junction of the base station 1 and the base station 2. In that case, the MEP 200 classifies the mobile device into the corresponding mobile device list of the base station 1 and the base station 2.

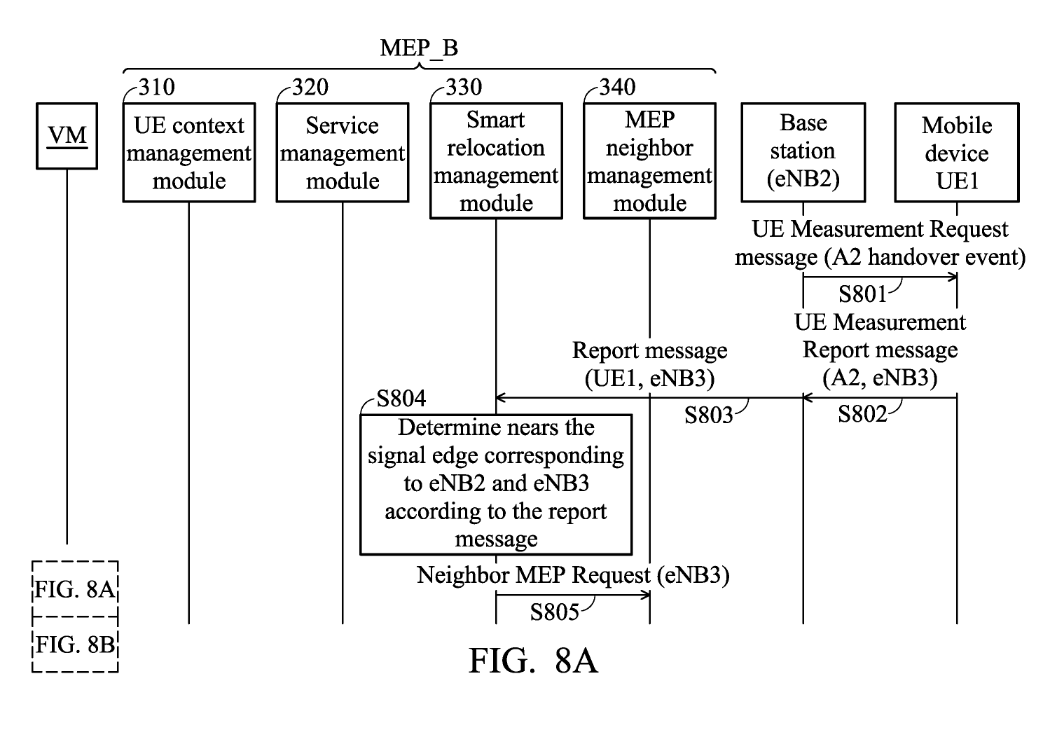

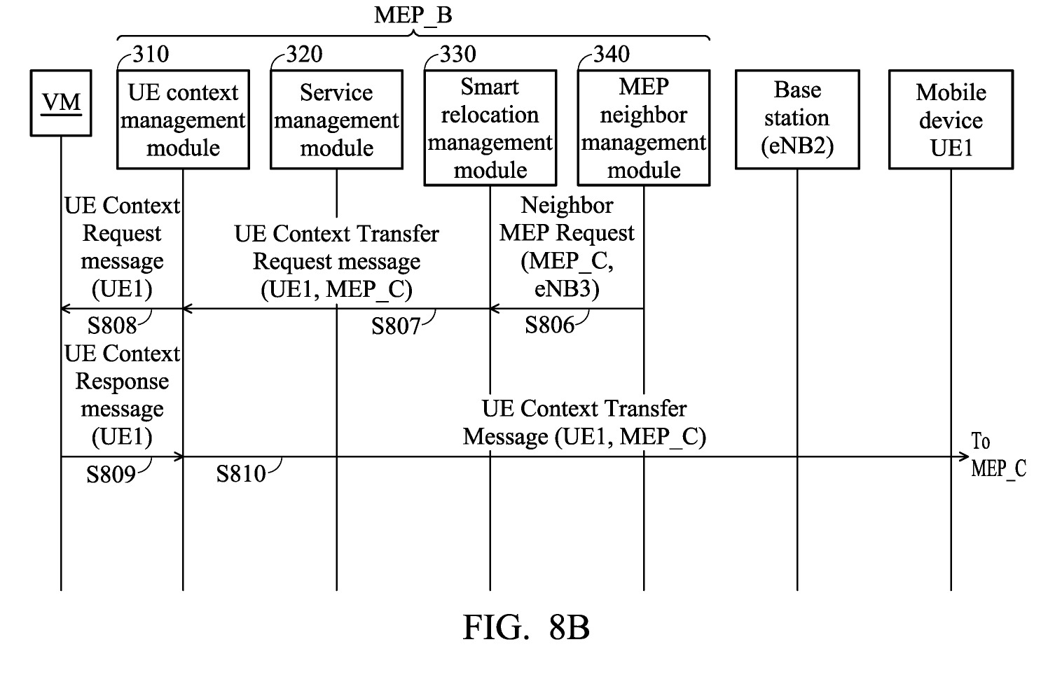

After generating the mobile device list corresponding to the base stations 122 and the neighboring base stations 124, in step S508, the controller 220 of the MEP 200 performs a message broadcasting operation on V2X messages of the mobile device between the base station 122 and the neighboring base station 124 using the mobile device list corresponding to the base station 122 and the neighboring base stations 124 through the communication device 210. The related device and message management of the V2X messages will be described in more detail with referring to subsequent FIGS. 8A-8B.

In some embodiments, it is assumed that the base station 122 is nearer to a third base station and the base station signal strength information includes first signal strength information corresponding to the third base station, and the controller 220 may generate a mobile device list corresponding to the base station 122 and the third base station according to the determined current location of the mobile device 110 and the first signal strength information, wherein, the controller 220 adds the mobile device 110 to the mobile device list corresponding to the base station 122 and the third base station in response to determining that the current location of the mobile device 110 is the signal edge of the base station 122 and the third base station. Thereafter, the message broadcasting operation on the V2X messages of the mobile device between the base station 122 and the third base station can be performed be using the mobile device list corresponding to the base station 122 and the third base station. In other words, when the current location of the mobile device 110 is at the signal edge and the signals of multiple base stations are detected at the same time, it means that the mobile device 110 is located in the signal overlapping areas of these base stations at the same time. Therefore, the mobile device 110 may respectively add these base stations to the corresponding mobile device lists.

In one embodiment, the MEP 200 may also perform the message broadcasting operation on the V2X messages of the mobile device 110 between the base station 122 and the neighboring base station 124 through the neighboring MEP, and the controller of the MEP 200 may also obtain information about a neighboring mobile edge platform 122 of the base station 124 and send the V2X messages of the mobile device 110 to the neighboring MEP 122, wherein the V2X messages of the mobile device 110 include a mobile device list. In another embodiment, the MEP 200 may further perform the message broadcasting operation on the V2X messages of the mobile device 110 between the base station 122 and the neighboring base station 124 through the neighboring MEP, and the neighboring MEP may actively perform the message broadcasting operation on the V2X messages so that the controller 220 of the MEP 200 can also receive a V2X message corresponding to the current location of the mobile device 110 from the neighboring MEP through the communication device 210. For example, the V2X message corresponding to the current location of the mobile device 110 can be a corresponding V2X message stored by the neighboring MEP, such as traffic information in front of the mobile device 110 and corresponding V2X message of an edge mobile device.

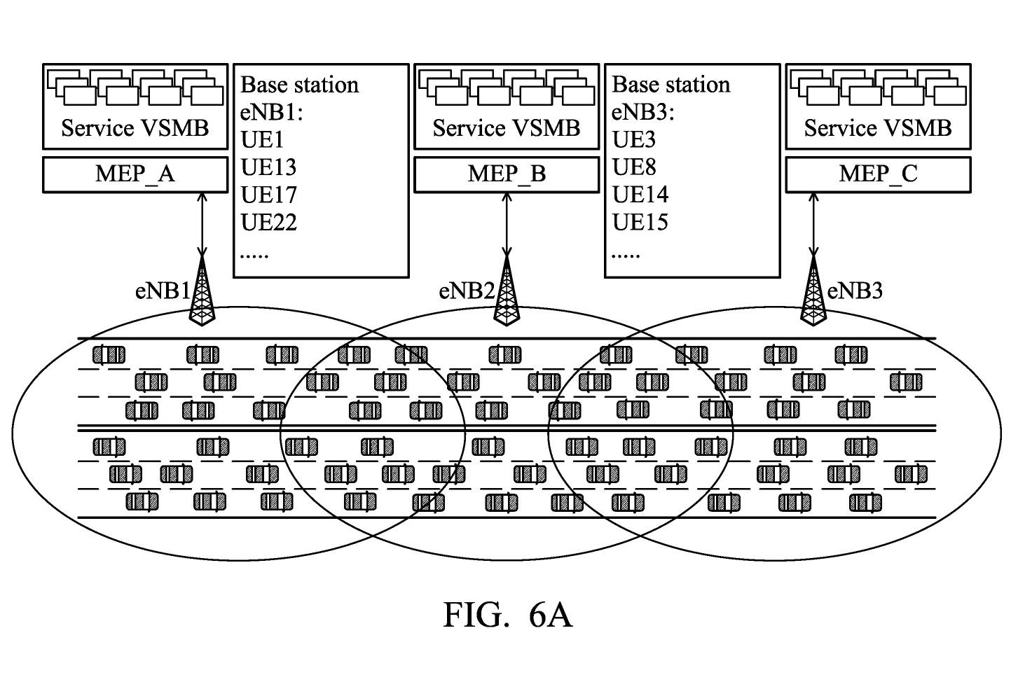

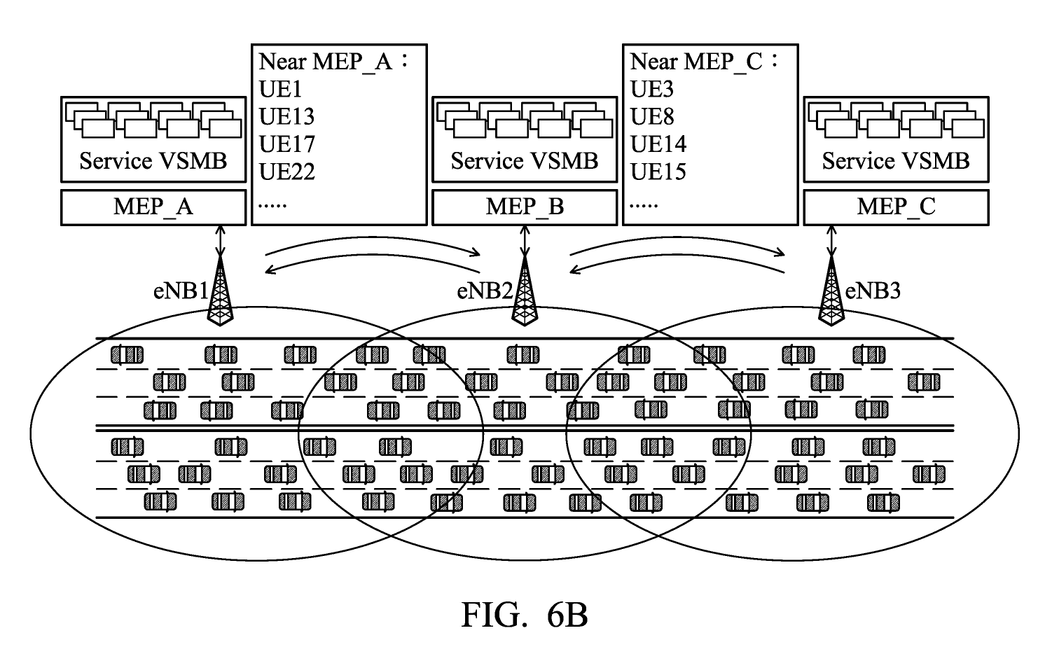

FIGS. 6A-6B show a schematic diagram illustrating an exemplary embodiment of mobile device list and vehicle-to-everything (V2X) message management between the mobile edge platforms. As shown in FIG. 6A, the mobile edge platform MEP_A is connected to a base station eNB1, the mobile edge platform MEP_B is connected to a base station eNB2 and the mobile edge platform MEP_C is connected to a base station eNB3, wherein the mobile edge platform MEP_B provides a V2X application service VSMB that can be executed by the mobile device UEx and stores UE contexts (e.g., V2X messages) corresponding to the V2X application service VSMB of the mobile device UEx. The V2X messages may include traffic information and vehicle safety information such as vehicle speed, volume, model type, heading direction and other information. UEx denotes a mobile device with an identification code x. In this embodiment, the base stations eNB1, eNB2, and eNB3 are disposed in a fixed location and are configured to communicate with one or more mobile devices UE (e.g., the mobile device 110) having mobility capability. For example, in some embodiments, the base station may be a roadside unit (RSU) integrated with an evolved base station (eNB), the mobile device UEx may be a vehicle traveling on the road, and the roadside unit may be connected to a plurality of vehicles to form a V2X communication network with other roadside units to communicate with each other to perform a V2X service. However, those skilled in the art should understand that the present invention is not limited thereto.

In FIG. 6A, the mobile edge platform MEP_B may transmit a measurement configuration to all mobile devices UEs in the service range through the base station eNB2, and collect, by the base station eNB2, the measured neighboring base station signals reported by each mobile device UE that performs a measurement on the measurement object in the measurement configuration, combines all the information and sets up the neighbor relationship with the mobile edge platform MEP_A and the mobile edge platform MEP_C according to the reported base station signal strength. That is, the mobile edge platform MEP_B may know from the base station signals that there are two neighboring base stations eNB1 and eNB3 and may further retrieve neighboring platform information including the location information of multiple neighboring mobile edge platforms by exchanging messages with other mobile edge platforms, and then obtain that the mobile edge platform corresponding to eNB1 is MEP_A and the mobile edge platform corresponding to eNB3 is MEP_C according to the neighboring platform information.

Thereafter, the mobile edge platform MEP_B may apply different measurement requests to all the UEs in the service range through the base station eNB2 to determine whether each UE arrives signal edges of the base station eNB2 based on the measurement result in the UE measurement report message. The mobile edge platform MEP_B may regard the UEs that arrive the signal edge as edge UEs.

The mobile edge platform MEP_B first determines which UEs are edge UEs located at the signal edge. In this embodiment, it is assumed that the signal strength information of the base station eNB2 measured by UEs UE1, UE3, UE8, UE13, UE14, UE15, UE17, and UE22 are lower than a threshold, and therefore they can be regarded as the edge UEs.

In the embodiment of FIG. 6A, it is assumed that the signal edge of the mobile edge platform MEP_B is divided into a first edge area and a second edge area, where the first edge area corresponds to the base station eNB1 and the second edge area corresponds to the base station eNB3. Next, the mobile edge platform MEP_B determines whether these edge UEs are located in which edge area. In this embodiment, the signal strengths of the base station eNB1 measured by the UE1, the UE13, the UE17 and the UE22 are greater than a threshold value, which indicate that the UE1, the UE13, the UE17 and the UE22 are located at the signal edge of the base station eNB2 and located at a signal overlapping area between the base station eNB2 and the base station eNB1, and thus the mobile edge platform MEP_B determines that the UE1, the UE13, the UE17 and the UE22 are located in the first edge area corresponding to the base station eNB1 and adds the UE1, the UE13, the UE17 and the UE22 into a first edge UE list for the base stations eNB1 and eNB2. Similarly, the signal strengths of the base station eNB3 measured by the UE3, the UE8, the UE14 and the UE15 are greater than a threshold value, which indicate that the UE3, the UE8, the UE14 and the UE15 are located at the signal edge of the base station eNB3 and located at a signal overlapping area between the base station eNB2 and the base station eNB3, and thus the mobile edge platform MEP_B determines that the UE3, the UE8, the UE14 and the UE15 are located in the second edge area corresponding to the base station eNB3 and adds the UE3, the UE8, the UE14 and the UE15 into a second edge UE list for the base stations eNB2 and eNB3.

After the mobile edge platform MEP_B respectively generates the first edge UE list corresponding to the base station eNB1 and the second edge UE list corresponding to the base station eNB3, it determines, by query, that the corresponding mobile edge platforms of the base station eNB1 and the base station eNB3 are MEP_A and MEP_C, respectively, as shown in FIG. 6B, and converts the first edge UE list corresponding to the base stations eNB1 and eNB2 into a third edge UE list corresponding to the mobile edge platforms MEP_A and MEP_B, and converts the second edge UE list corresponding to the base stations eNB2 and eNB3 into a fourth edge UE list corresponding to the mobile edge platforms MEP_B and MEP_C.

Thereafter, the mobile edge platform MEP_B obtains the V2X messages, such as vehicle safety information, to be transmitted to the mobile edge platform MEP_A according to the third edge UE list and transmits the above V2X messages to the mobile edge platform MEP_A. Specifically, the V2X messages to be transmitted to the mobile edge platform MEP_A include V2X messages corresponding to all UEs (i.e., UE1, UE13, UE17, and UE22) in the third edge UE list. Similarly, the mobile edge platform MEP_B also obtains V2X messages, such as vehicle safety information, to be transmitted to the mobile edge platform MEP_C and transmits the above V2X messages to the mobile edge platform MEP_A according to the fourth edge UE list. Specifically, the V2X messages to be transmitted to the mobile edge platform MEP_C include the V2X messages corresponding to all the UEs (i.e., UE3, UE8, UE14, and UE15) in the fourth edge UE list.

Similarly, the mobile edge platform MEP_B may also receive the V2X messages of all the UEs in its bounding UE list from the mobile edge platform MEP_A and receive the V2X messages of all the UEs in its bounding UE list from the mobile edge platform MEP_C and broadcast the receive V2X messages to all the UEs via the base station eNB2.

Thus, the MEP is responsible for managing and delivering V2X service messages, monitoring the signal strength information of vehicles within the service range and determining the moving direction and time. When a vehicle located at the signal edge is about to enter the neighboring MEP, the MEP notifies the other party's MEP to obtain required vehicle information and sends V2X messages, such as vehicle safety information, to the other party's MEP, so that vehicle and road condition information at the signal edge can be transmitted in advance and the vehicle and road condition collected from another signal edge can be received, thereby effectively solving the problem of concern over safety if ever a vehicle reaching the MEP service edge has a blind spot preventing it from obtaining necessary information from the neighboring MEP.

For explanation, specific device and message management methods for V2X messages applied to the MEP are illustrated as actual implementation examples in the following embodiments, and those skilled in the art will understand that the present application is not limited thereto.

FIGS. 7A-7B show a message sequence chart illustrating the device and message method of V2X service when the mobile device UE1 (e.g., the mobile device 110 of FIG. 1) is located at a signal boundary according to an embodiment of the application. Please refer together with FIG. 4. In this embodiment, consider that the mobile device UE1 moves from the service area of a base station eNB2 on the mobile edge platform MEP_B to the service area of a base station eNB3 of the neighboring mobile edge platform MEP_C, wherein the mobile edge platform MEP_B provides a V2X application service VSMB that can be executed by the mobile device UE1 and stores necessary vehicle safety information C1 corresponding to the V2X application service VSMB of the mobile device UE1.

In this embodiment, the mobile edge platform MEP_B includes the architecture as same as those shown in FIG. 2 and FIG. 3. The mobile edge platform MEP_B includes a UE context management module 310, a service management module 320, a smart relocation management module 330, and a MEP neighbor management module 340. The necessary vehicle safety information C1 corresponding to the V2X application service VSMB of the mobile device UE1 is stored in a virtual machine VM in the mobile edge platform MEP_B.

As shown in FIG. 7A, when the mobile device UE1 moves into the signal coverage range of the base station eNB2 of the mobile edge platform MEP_B, the base station eNB2 transmits a UE measurement request message (UE Measurement Request Message to the mobile device UE1 (S701). In this embodiment, the measurement configuration data is set as (RSRP, RSRQ) which indicate that the mobile device UE1 needs to provide signal strength information including the RSRP data and the RSRQ data of the neighboring base stations.

After receiving the measurement request message, the mobile device UE1 performs measurement on the neighboring base stations according to the measurement object in the measurement configuration data to obtain corresponding RSRP and RSRQ information, and the mobile device UE1 transmits the measurement result to the base station eNB2 through a measurement report message (S702). The measurement result includes signal strength information of all the base stations measured by the mobile device UE1, and the signal strength information includes RSRP data and RSRQ data. In this embodiment, the UE measurement report message includes RSRP data and RSRQ data of the neighboring base station eNB3 measured by the mobile device UE1.

Next, the base station eNB2 transmits the base station signal strength information including the RSRP information and RSRQ information of the base station eNB3 measured by the mobile device UE1 to the smart relocation management module 330 on the mobile edge platform MEP_B (S703). The smart relocation management module 330 then determines whether the mobile device UE1 has arrived at the signal edge of the base stations eNB2 and eNB3 according to the RSRP information and the RSRQ information in the base station signal strength information. The smart relocation management module 330 may determine whether the mobile device UE1 has arrived at the signal edge of the base stations eNB2 and eNB3 by determining whether the RSRP and RSRQ signals of the base stations eNB2 and eNB3 are both greater than the preset thresholds. In this embodiment, assuming that RSRP and RSRQ signals of the base station eNB3 are both greater than the preset threshold, the smart relocation management module 330 determines that the mobile device UE1 is close to the signal edge corresponding to the base station eNB2 and eNB3 (S704).

Next, the smart relocation management module 330 sends a Neighbor MEP Information Request Message including at least a base station identifier (BS ID) to the MEP neighbor management module 340 (S705). In this embodiment, the base station identifier is eNB3. After receiving the Neighbor MEP Information Request Message, as shown in FIG. 7B, the MEP neighbor management module 340 performs a Neighbor MEP Information extraction for extracting the neighbor MEP information. Since the MEP neighbor management module 340 can collect the information of all the peripheral MEPs by communicating information with the corresponding MEP neighbor management module of each neighboring MEP, it is possible to obtain the information of MEP identifier (MEP IP) corresponding to the base station identifier (eNB3). The MEP identifier indicates which MEP the base station corresponding to the base station identifier eNB3 belongs to. In this embodiment, since the corresponding mobile edge platform of the base station eNB3 is MEP_C, the MEP identifier is MEP_C.

After obtaining the MEP identifier (MEP_C) corresponding to the base station identifier (eNB3), the MEP neighbor management module 340 sends to the smart relocation management module 330 a Neighbor MEP Information Response message including at least the base station identifier (eNB3) and the MEP identifier (MEP_C) (S706). In this embodiment, the MEP identifier is MEP_C. That is, the mobile edge platform MEP_B may determine that the mobile device UE1 nears the signal edge corresponding to the base station eNB2 and eNB3 according to the base station identifier, and therefore it adds the mobile device UE1 into the edge UE list corresponding to the signal edge of the base stations eNB2 and eNB3.

The smart relocation management module 330 on the mobile edge platform MEP_B then transmits a UE context transfer request (UE Context Transfer Request) including a UE identifier (UE1) and a neighbor MEP identifier (MEP_C) to the UE context management module 310 to obtain the UE context to be transmitted (S707).

In response thereto, the UE context management module 310 performs a procedure of retrieving the UE context, and sends, according to the UE identifier (UE1), a UE Context Request message at least including a UE identifier (UE1) to the virtual machine VM where the UE context is located through the API (S708).

In response to the UE Context Request message, the virtual machine VMA obtains a V2X message (e.g., necessary vehicle safety information C1) corresponding to the UE identifier according to the UE identifier (UE1), and sends a UE Context Response message including at least the UE identifier (UE1) and the obtained V2X message C1 to the UE context management module 310 (S709).

After obtaining the UE Context Response message, the UE context management module 310 then, by sending a UE Context Transfer message at least including the obtained V2X message C1 and the MEP identifier (MEP_C), transmits the respective V2X message C1 of UE1 to the mobile edge platform MEP_C (S710) to complete the vehicle networking message broadcast of the single UE across the mobile edge platform to complete the V2X message broadcasting operation among the MEPs for single UE once. Similarly, the above message sequence from FIG. 7A to FIG. 7B may further be applied to a cross-mobile edge platform V2X message broadcasting operation among all the mobile devices in an edge UE list corresponding to a signal edge of the base station eNB3.

FIGS. 8A-8B show a message sequence chart illustrating the device and message method of V2X service when the mobile device UE1 (e.g., the mobile device 110 of FIG. 1) is located at a signal boundary according to an embodiment of the application. Please refer together with FIG. 5. In this embodiment, consider that the mobile device UE1 moves from the service area of a base station eNB2 on the mobile edge platform MEP_B to the service area of a base station eNB3 of the neighboring mobile edge platform MEP_C, wherein the mobile edge platform MEP_B provides a V2X application service VSMB that can be executed by the mobile device UE1 and stores necessary vehicle safety information C1 corresponding to the V2X application service VSMB of the mobile device UE1.

In this embodiment, the mobile edge platform MEP_B includes the architecture as same as those shown in FIG. 2 and FIG. 3. The mobile edge platform MEP_B includes a UE context management module 310, a service management module 320, a smart relocation management module 330, and a MEP neighbor management module 340. The necessary vehicle safety information C1 corresponding to the V2X application service VSMB of the mobile device UE1 is stored in a virtual machine VM in the mobile edge platform MEP_B.

As shown in FIG. 8A, the base station eNB2 transmits a UE measurement request message including at least measurement configuration data of an A2 handover event to all the mobile devices UE1 within its signal coverage range (S801).

After receiving the measurement request message, the mobile device UE1 performs an A2 event-triggered measurement on the currently serving base station eNB2 to obtain the measurement result of the mobile device UE1 about a neighboring base station set that collects all neighboring base stations that trigger A2 events measured by the mobile device UE1 according to the measurement object in the measurement configuration. The mobile device UE1 transmits the measurement result to the base station eNB2 through a measurement report message. The measurement result includes all neighboring base stations that trigger the A2 event collected by the mobile device UE1, where the A2 event represents that the signal quality of the serving cell is lower than a preset threshold. In this embodiment, the mobile device UE1 is located at the signal boundary between the base station eNB2 and the base station eNB3. Therefore, the mobile device UE1 can measure the signals of the base station eNB2 and the base station eNB3 at the same time and it measures that the signal quality of the base station eNB2 will be lower than a preset threshold to trigger the report procedure triggered on the A2 event. Therefore, a UE measurement report message including at least a base station identifier eNB3 and a trigger event identifier (event ID) A2 is transmitted back to the base station eNB2 (S802).

Thereafter, the base station eNB2 transmits a report message at least including a UE identifier of UE1 and a base station identifier of eNB3 to the smart relocation management module 330 on the mobile edge platform MEP_B (S803). The smart relocation management module 330 then determines that the mobile device UE1 has arrived at the signal edge of the base station eNB2 according to a triggering-event identifier (A2) in the report message and determines that the mobile device UE1 nears the signal edge corresponding to the base stations eNB2 and eNB3 according to the base station identifier (eNB3) (S804). For example, the smart relocation management module 330 may determine whether the mobile device UE1 has arrived at the signal edge of the base station eNB2 by determining whether the RSRP data of the base station eNB3 can be obtained or whether the RSRP data is greater than a first threshold.

Next, the smart relocation management module 330 sends a Neighbor MEP Information Request Message including at least a base station identifier (BS ID) to the MEP neighbor management module 340 (S805). In this embodiment, the base station identifier is eNB3. After receiving the Neighbor MEP Information Request Message, as shown in FIG. 8B, the MEP neighbor management module 340 performs a Neighbor MEP Information extraction for extracting the neighbor MEP information. Since the MEP neighbor management module 340 can collect the information of all the peripheral MEPs by communicating information with the corresponding MEP neighbor management module of each neighboring MEP, it is possible to obtain the information of MEP identifier (MEP IP) corresponding to the base station identifier (eNB3). The MEP identifier indicates which MEP the base station corresponding to the base station identifier eNB3 belongs to. In this embodiment, since the corresponding mobile edge platform of the base station eNB3 is MEP_C, the MEP identifier is MEP_C.

After obtaining the MEP identifier (MEP_C) corresponding to the base station identifier (eNB3), the MEP neighbor management module 340 sends to the smart relocation management module 330 a Neighbor MEP Information Response message including at least the base station identifier (eNB3) and the MEP identifier (MEP_C) (S806). In this embodiment, the MEP identifier is MEP_C. That is, the mobile edge platform MEP_B may determine that the mobile device UE1 nears the signal edge of the corresponding base station eNB3 according to the base station identifier, and therefore it adds the mobile device UE1 into the edge UE list corresponding to the signal boundary of the base stations eNB2 and eNB3, and it can be known by the MEP identifier that the signal broadcasting operation is to be performed through the mobile edge platform MEP_C.

The smart relocation management module 330 on the mobile edge platform MEP_B then transmits a UE context transfer request (UE Context Transfer Request) including a UE identifier (UE1) and a MEP identifier (MEP_C) to the UE context management module 310 (S807).

In response thereto, the UE context management module 310 performs a procedure of retrieving the UE context, and sends, according to the UE identifier (UE1), a UE Context Request message at least including a UE identifier (UE1) to the virtual machine VM where the UE context is located through the API (S808).

In response to the UE Context Request message, the virtual machine VMA obtains a V2X message (e.g., necessary vehicle safety information C1) corresponding to the UE identifier according to the UE identifier (UE1), and sends a UE Context Response message including at least the UE identifier (UE1) and the obtained V2X message C1 to the UE context management module 310 (S809).

After obtaining the UE Context Response message, the UE context management module 310 then, by sending a UE Context Transfer message at least including the obtained V2X message C1 and the MEP identifier (MEP_C), transmits the respective V2X message C1 of UE1 to the mobile edge platform MEP_C (S810) to complete the vehicle networking message broadcast of the single UE across the mobile edge platform to complete the V2X message broadcasting operation among the MEPs for single UE once. Similarly, the above message sequence from FIG. 8A to FIG. 8B may further be applied to a cross-mobile edge platform V2X message broadcasting operation among all the mobile devices in an edge UE list corresponding to a signal edge of the0 base station eNB3.

It should be understood that the above-mentioned methods for generating edge mobile device list of signal edges of each base station is merely used for description, but the present application is not limited thereto. For example, in other embodiments, when multiple neighboring base stations have a mobile device positioning function, specific positioning signals may also be respectively sent to the mobile devices by the neighboring base stations at different fixed angles for performing the mobile device's Then, the location of the mobile device can be calculated according to the angle, distance, signal reception time, etc. of each neighboring base station, so as to find out all the edge mobile devices at the signal edge and establish the above edge mobile device list.

Methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application specific logic circuits.

It should be noted that, the terms “first,” “second,” and so forth in the appended claims, are used merely as labels, and are not intended to impose any numerical requirements, any time order, priority order, or other relationship on the described elements, but rather are used to distinguish between different elements with the same name.

While the application has been described by way of example and in terms of exemplary embodiment, it is to be understood that the application is not limited thereto. Those who are skilled in this technology can still make various alterations and modifications without departing from the scope and spirit of this application. For example, the systems and methods described in the embodiments of the present APPLICATION may be implemented in physical embodiments of hardware, software, or a combination of hardware and software. Therefore, the scope of the present application shall be defined and protected by the following claims and their equivalents.

### SYMBOL DESCRIPTION

100˜mobile communication environment;
110˜mobile device;
120˜service network;
122, 124˜base station;
130˜mobile edge computing network;
140˜core network;
150˜mobile edge platform server;
152˜virtual machine;
C1, C2˜user device context;
200˜mobile edge platform;
210˜communication device;
220˜controller;
230˜storage device;
310, 320, 330, 340˜management modules;
S402, S404, S406, S408˜steps;
S502, S504, S506, S508˜steps;
MEP_A, MEP_B, MEP_C˜mobile edge platform;
UE, UE1, UEx˜mobile devices;
eNB1, eNB2, eNB3˜base stations;
310, 320, 330, 340˜management modules;
VM˜virtual machine;
S701, S702, . . . , S710˜steps; and
S801, S802, . . . , S810˜steps.

What is claimed is:

1. A device and message management method for vehicle-to-everything (V2X) service applied to a mobile edge platform (MEP) for managing a mobile device and V2X messages thereof, wherein the mobile edge platform is connected to the mobile device through a first base station and the first base station is neighboring to a second base station, the method comprising:
obtaining a mobile device signal strength information and base station signal strength information from the first base station;
determining a current location of the mobile device based on the mobile device signal strength information; and
generating a mobile device list corresponding to the first base station and the second base station based on the current location of the mobile device and the base station signal strength information,
wherein the mobile device is added to the mobile device list when determining that the current location of the mobile device is located at a signal edge between the first base station and the second base station.

2. The device and message management method for V2X service as claimed in claim 1, wherein the base station signal strength information comprises reference signal receiving power (RSRP) data and reference signal received quality (RSRQ) data of the second base station.

3. The device and message management method for V2X service as claimed in claim 2, wherein the step of generating the mobile device list corresponding to the first base station and the second base station based on the current location of the mobile device and the base station signal strength information further comprises:
determining that the current location of the mobile device is a signal edge of the first base station according to the mobile device signal strength information;
determining whether the reference signal receiving power data is greater than a first threshold and the reference signal received quality data is greater than a second threshold after determining that a current position of the mobile device is the signal edge of the first base station; and
determining that the current location of the mobile device is the signal edge of the first base station and the second base station, and adding the mobile device to the mobile device list in response to determining that the reference signal receiving power data is greater than the first threshold and the reference signal received quality data is greater than the second threshold.

4. The device and message management method for V2X service as claimed in claim 1, wherein the first base station is further neighboring to a third base station, the base station signal strength information comprises first signal strength information corresponding to the third base station and the method further comprises:
generating a mobile device list corresponding to the first base station and the third base station according to the determined current location of the mobile device and the first signal strength information,
wherein the mobile device is added to the mobile device list corresponding to the first base station and the third base station when determining that the current location of the mobile device is located at a signal edge between the first base station and the third base station.

5. The device and message management method for V2X service as claimed in claim 1, further comprising:
performing a message broadcasting operation on the V2X messages of the mobile device between the first base station and the second base station using the mobile device list.

6. The device and message management method for V2X service as claimed in claim 1, further comprising:
obtaining information about a neighboring mobile edge platform of the second base station and transmitting the V2X messages of the mobile device to the neighboring mobile edge platform, wherein the V2X messages of the mobile device includes the mobile device list.

7. The device and message management method for V2X service as claimed in claim 6, further comprising:
performing a message broadcasting operation on the V2X messages of the mobile device between the first base station and the second base station through the neighboring mobile edge platform.

8. The device and message management method for V2X service as claimed in claim 6, further comprising:
receiving a V2X message corresponding to the current location of the mobile device from the neighboring mobile edge platform.

9. The device and message management method for V2X service as claimed in claim 1, further comprising:
transmitting a signal strength measurement request to request the first base station to provide the mobile device signal strength information and the base station signal strength information.

10. The device and message management method for V2X service as claimed in claim 1, wherein the mobile device signal strength information and the base station signal strength information are obtained by the mobile device that performs a signal strength measurement on the first base station and the second base stations.

11. A device and message management method for vehicle-to-everything (V2X) service applied to a mobile edge platform (MEP) for managing a mobile device and V2X messages thereof, wherein the mobile edge platform is connected to the mobile device through a first base station and the first base station is neighboring to a second base station, the method comprising:
receiving a report message regarding whether the mobile device has triggered a predetermined handover event and base station signal strength information provided by the mobile device from the first base station;
determining a current location of the mobile device based on the report message; and
generating a mobile device list corresponding to the first base station and the second base station based on the current location of the mobile device and the base station signal strength information,
wherein the mobile device is added to the mobile device list when determining that the current location of the mobile device is located at a signal edge between the first base station and the second base station.

12. The device and message management method for V2X service as claimed in claim 11, wherein the base station signal strength information comprises reference signal receiving power (RSRP) data of the second base station.

13. The device and message management method for V2X service as claimed in claim 12, wherein the step of generating the mobile device list corresponding to the first base station and the second base station based on the current location of the mobile device and the base station signal strength information further comprises:
determining that the current location of the mobile device is a signal edge of the first base station when the report message indicates that the mobile device has triggered the predetermined handover event;
determining whether the reference signal receiving power data is greater than a first threshold after determining that the current position of the mobile device is the signal edge of the first base station; and
determining that a current location of the mobile device is the signal edge of the first base station and the second base station, and adding the mobile device to the mobile device list in response to determining that the reference signal receiving power data is greater than the first threshold.

14. The device and message management method for V2X service as claimed in claim 13, wherein the first base station is further neighboring to a third base station, the base station signal strength information comprises first signal strength information corresponding to the third base station and the method further comprises:
generating a mobile device list corresponding to the first base station and the third base station according to the current location of the mobile device and the first signal strength information,
wherein the mobile device is added to the mobile device list corresponding to the first base station and the third base station when determining that the current location of the mobile device is located at a signal edge between the first base station and the third base station.

15. The device and message management method for V2X service as claimed in claim 11, further comprising:
performing a message broadcasting operation on the V2X messages of the mobile device between the first base station and the second base station using the mobile device list.

16. The device and message management method for V2X service as claimed in claim 11, further comprising:
obtaining information about a neighboring mobile edge platform of the second base station and transmitting the V2X messages of the mobile device to the neighboring mobile edge platform, wherein the V2X messages of the mobile device includes the mobile device list; and
performing a message broadcasting operation on the V2X messages of the mobile device between the first base station and the second base station through the neighboring mobile edge platform.

17. The device and message management method for V2X service as claimed in claim 11, further comprising:
transmitting a measurement request to the first base station to request the first base station to provide the report message regarding whether the mobile device has triggered the predetermined handover event and the base station signal strength information.

18. The device and message management method for V2X service as claimed in claim 11, wherein the predetermined handover event is triggered when the base station signal strength information of the first base station is below a predetermined threshold.

19. A mobile edge platform server, applied to a mobile edge computing network for managing a mobile device, comprising:
a mobile edge platform, comprising:
a communication device configured to perform signal transmission and reception with at least one first base station and wireless transmission and reception with the mobile device; and
a controller configured to obtain mobile device signal strength information and base station signal strength information from the first base station via the communication device, determine current location of the mobile device based on the mobile device signal strength information, and generate a mobile device list corresponding to the first base station and a second base station based on the current location of the mobile device and the base station signal strength information,
wherein the controller adds the mobile device to the mobile device list when determining that the current location of the mobile device is located at a signal edge between the first base station and the second base station.

20. A mobile edge platform server, applied to a mobile edge computing network for managing a mobile device, comprising:
a mobile edge platform, comprising:
a communication device configured to perform signal transmission and reception with at least one first base station and wireless transmission and reception with the mobile device; and
a controller configured to receive a report message regarding whether the mobile device has triggered a predetermined handover event and base station signal strength information provided by the mobile device from the first base station via the communication device, determine current location of the mobile device based on the report message, and generate a mobile device list corresponding to the first base station and a second base station based on the current location of the mobile device and the base station signal strength information,
wherein the controller adds the mobile device to the mobile device list when determining that the current location of the mobile device is located at a signal edge between the first base station and the second base station.
